(19) United States
(12) Patent Application Publication
(10) Pub. No.: US 2005/0095310 A1
(43) Pub. Date: May 5, 2005

(54) Rotary tablet press comprising a die sealing element and corresponding die sealing element

(76) Inventor: Hans Kramer, Koln (DE)

Correspondence Address: Orum & Roth, 53 West Jackson Boulevard, Chicago, IL, 60604, US

(21) Appl. No.: 10/510,793

(22) PCT Filed: Apr. 2, 2003
(86) PCT No.: PCT/EP03/03468

(30) Foreign Application Priority Data
Apr. 9, 2002 (DE) 202 05 508.6

(51) Int. Cl. B29C 51/18

(52) U.S. Cl. 425/345; 425/353; 425/348 R

(57) ABSTRACT

The invention relates to a rotary tablet press with rotating die table and with stamp guide discs 4 that, coaxial to the dies, have stamp guides for the shafts of upper and lower stamps. The invention also relates to the elastic stamp sealing elements used with the tablet presses, that can be attached to form a seal between the pressing area on the die table and the stamp guides. In order to allow the use of upper and lower stamps with rotary tablet presses other than those fitted with special attachment apparatus for bellows, and to re-use existing upper and lower stamps, wherein at the same time the stamp guides are protected from the incursion of press dust and the pressing area is protected from contamination by lubricating oil, the base section of the stamp sealing element has an undercut via which it can be releasably attached to a holding collar of a holding ring disposed concentrically about the stamp guide. The base section passes into a sleeve section, the free end of which forms a scraper lip that abuts on the stamp shaft in a sealing manner.

The invention relates to a rotary tablet press with rotating die table, with stamp guide discs that can be moved in conjunction with the die table and, coaxial to the dies in the die table, has stamp guides for the shafts of liftable upper and lower stamps, and with elastic stamp sealing elements, having rotational symmetry, for each upper and lower stamp, that can be attached to the stamp guide discs concentrically around the stamp guides with their base section to form a seal between the compression zone in the die table and the stamp guides. Furthermore, the invention also relates to the sealing elements and/or their use with rotary tablet presses.

Typical rotary tablet presses are known in a wide variety of forms and, among other uses, serve in the pharmaceutical industry for pressing pulverulent or granular pressing material into tablet form. When pressing tablets in rotary tablet presses, it cannot be avoided that dust from the pressed material results in the pressing area. Since this pressed material dust could get into the stamp guides of the die table and could lead to difficulties in manipulating the stamp into the stamp guides, it is known to attach one or more stamp sealing elements to the stamp guide discs for all upper and lower stamps.

For example, EP 623 456 A1 discloses a rotary tablet press with a flexible, annular intermediate wall that has an elastic nozzle with central opening for the shaft of each stamp and is attached to the upper or lower stamp guide ring. To attain the best possible seal, the intermediate wall is attached to the associated stamp guide disc around its inner and outer edge. The nozzles, that are configured in the manner of bellow seals, can compensate for the up-and-down movement of the stamp, wherein the opening at the front of the nozzle is fixed in a sealing manner in a groove provided on the stamp shaft.

A rotary tablet press with separate stamp sealing elements for each upper and lower stamp is known from DE 2 914 201 A1; each stamp sealing element is held by means of a collar in its base section in recesses in the stamp guide discs, disposed concentrically to the stamp guides. A sleeve section is attached to the base section, extending parallel to the stamp shaft over a comparatively large axial length and being at a distance from the stamp shaft at the free end of the sleeve section so that via an air flushing system, the stamp shafts can be kept free of tablet dust by being flushed with an air stream. However, this principle has the disadvantage that lubricant, which improves the sliding of the stamp shafts in the stamp guides, can get into the pressing area and can lead to contamination of the tablets that are to be pressed. Hence such stamp sealing systems are unsuitable for rotary tablet presses that are used for pressing e.g. foodstuffs such as vitamin tablets or pharmaceutical products.

The applicant has developed a new type of rotary tablet press for the foodstuffs and pharmaceutical industry, and has applied for a patent under the Italian file number BO2001A000082, wherein for each stamp shaft a bellow is provided as a stamp sealing element, this bellow engaging with its one end into a groove, or a special holding apparatus, on the stamp shaft and is fastened at its other end to a holding collar of a holding ring, attached concentrically to the stamp guides on the stamp guide discs. The bellows not only prevent the intrusion of product dust from the pressing area into the stamp guides, but in the opposite direction, the bellows also protect the pressing area from contamination by lubricant from the stamp guides. However, the bellows can only be used with upper and lower stamps that have the grooves and the special attachment apparatus on the heads of the stamp shafts. Amongst the operators of such rotary tablet presses, however, there are many upper and lower stamps being used as pressing tools that do not have the corresponding grooves and holding apparatus and could not therefore be further utilised on such rotary tablet presses.

Object of the invention is therefore to make it possible that such rotary tablet presses can use not only upper and lower stamps with special attachment apparatus for bellows, but can also use—and especially re-use—other, perhaps already existing, upper and lower stamps, wherein at the same time protection of the stamp guides from the intrusion of press dust and contamination of the pressing area with lubricant should be guaranteed.

This object is achieved with the invention of a rotary tablet press with the special stamp sealing element as described in claim 1, and with the stamp sealing element according to claim 11 that is provided for use with rotary tablet presses.

According to the invention, it is provided that the base section of the stamp sealing element has an undercut, with which the sealing element can be releasably attached to a holding collar of a holding ring, disposed concentrically about the stamp guide, and that the base section integrally passes into a substantially axially-extending sleeve section, the free end of which forms a scraper lip, abutting in a sealing manner on the stamp shaft. The undercut in the base section of the elastic stamp sealing element that has rotational symmetry renders it possible that the stamp sealing element can rapidly and without additional aids be pulled over the holding collar of the holding ring or can be clipped to the holding collar with the base section, and that it substantially abuts the holding collar, and hence the stamp guide disc, in a form-locking manner. In turn, the scraper lip of the sleeve section that is disposed at the stamp shaft prevents the incursion of press dust into the stamp guide and lubricant into the pressing area. Since the stamp sealing element is releasable, it can be easily and rapidly replaced once worn, and/or cleaned if the tablet press is used in the pharmaceutical industry.

In a preferred embodiment, the sleeve section has a reinforcement bulge in the area adjacent to the undercut so that the scraper lip rests against the stamp shaft with sufficient radial pre-tension and carries out its sealing function, in spite of the elasticity of the material from which the stamp sealing element is made. Here, it is especially advantageous if the sleeve section extends obliquely inwards like a wing-collar, preferably tapering, between the bulge and the scraper lip. In accordance with a preferred embodiment, the sleeve section is substantially concavely bent on its inner wall, and forms a second, inner scraper and retaining lip with its inner limiting edge with which the lubricant is kept back, maintaining the sealing function in the event of wear in one of the two scraper lips. Alternatively, the inner wall of the sleeve section can be configured cylindrically except for the wing-collar shaped section.

In order to facilitate rapid and efficient assembly of the stamp sealing element, it is especially preferred that the base section has a circulating engagement projection adjacent to the undercut, preferably being offset radially outwards opposite the inner wall of the sleeve section. When installed, the stamp sealing element grips behind the holding collar on the holding ring only with the engagement projection, whilst the reinforcement bulge abuts the flange surface of the holding collar on the die table side. In the case of the embodiment with the two scraper lips, these can both then project radially inwards over the holding collar of the holding ring and form the individual areas of the stamp sealing element that abut on the stamp shaft. It is also preferred that the engagement projection opens towards the underside of the stamp sealing element in a funnel-shaped expanding ring land, the wall thickness of which is less than 50% of the wall thickness in the area of the engagement projection, so that via the ring land and the gradients in the elasticity of the stamp sealing element, the engagement projection can be pulled outwards and the base section expanded for clipping to the holding collar when installing and removing the stamp sealing element by enveloping or pulling the funnel-shaped ring land. To assist in installation and removal, it is also advantageous if the outer wall of the stamp sealing element on the base section has a contraction between the funnel-shaped ring land and the area with the engagement projection, so that envelopment of the ring land is commenced and can be carried out more easily via the contraction. This is then especially advantageous if the axial length of the base section between the engagement projection and its underside is greater than the distance between the holding collar and the stamp guide disc, since with these geometric dimensions the underside of the base section abuts on the stamp guide disc in the installed state and forms an additional seal to prevent the incursion of press dust into the interior of the stamp sealing element.

As mentioned above, the invention also relates to the stamp sealing element for use with a rotary tablet press with rotating die table and with stamp guide discs that can be moved with the die table and have stamp guides disposed coaxial to the dies in the die table for the shafts of upper and lower stamps that can be moved up and down, wherein an elastic stamp sealing element that has rotational symmetry is provided for each upper and lower stamp to provide a seal between the pressing area of the die table and the stamp guides, this stamp sealing element being attachable with a base section concentrically around the stamp guides to the stamp guide discs and being characterised in that the base section of the stamp sealing element has an undercut via which it is releasably attachable or clippable to a holding collar of a holding ring disposed concentrically around the stamp guide, and that the base section passes into a substantially axially-extending sleeve section, the free end of which forms a scraper lip, abutting in a sealing manner on the stamp shaft.

The invention will now be described with reference to a schematic embodiment example as shown in the drawing. The following are shown:

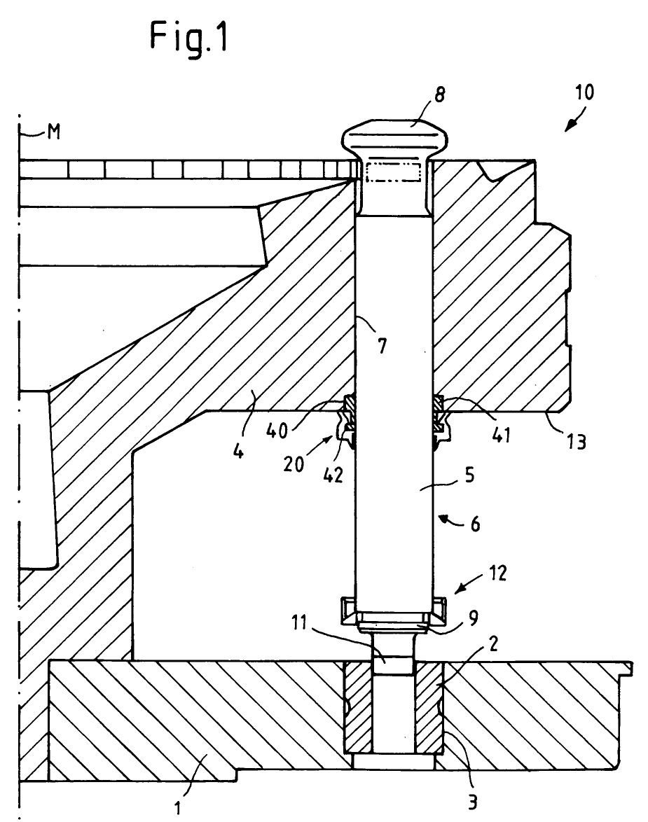

FIG. 1 in a vertical partial cross-section of a section of a tablet press with die table, stamp guide disc for the upper stamp and stamp sealing element according to the invention;

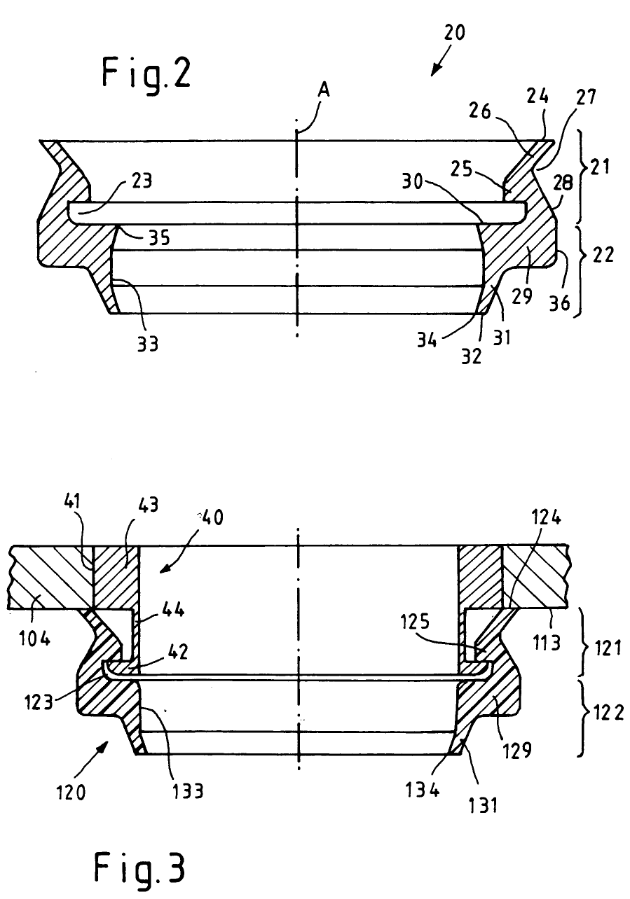

FIG. 2 a detailed cross-section through the stamp sealing element of FIG. 1; and

FIG. 3 a holding ring with stamp sealing element according to a second embodiment example.

The rotary tablet press 10 shown in FIG. 1 has a die table 1 rotating about a central axis M with a row of dies 2 distributed on an arc, inserted in die bores 3 on the die table 1. The tablet press 10 also has an upper stamp guide disc 4, here separate, that is moveable with the die table 1, with upper stamp guide 7 for the upper stamp 6, disposed coaxial to each die 2 in the die table 1 and, not illustrated, a lower stamp guide disc, also moveable with the die table 1, with correspondingly-formed stamp guides for all lower stamps. The illustrated upper stamp 6 is accepted in a manner so that it can be moved up and down with its stamp shaft 5 in a bore in the upper stamp guide disc 4, forming a stamp guide 7 for the upper stamp 6. In order that the stamp shafts 5 glide in the stamp guides 7, these are lubricated with suitable lubricating oil. For rotation of the die table 1 together with the upper and lower stamp guide disc 4, the lifting movement of all upper stamps 6 and all lower stamps is effected by sliding rails, not illustrated, on the rotary tablet press 10, in which the lower ends 8 of all upper stamps 6 and all lower stamps are coercively guided. The stamp head 11, attached to the upper end 9 of each upper stamp 6, engages in the die 2 and together with the lower stamp, moved in the opposite direction from below, effects pressing of the product dust, not illustrated, into solid tablets.

In the illustrated embodiment example, the upper stamp 6 has an attachment apparatus 12 at its upper end 9, to which the one end of a bellow could be attached as a sealing element. This attachment apparatus 12 is not required for the invention, since in accordance with the invention stamp sealing elements 20 are used that are clipped releasably onto a holding ring, denoted in its entirety as 40, attached concentrically to the stamp guide 7 of each upper stamp 6 in a recess, here shown as a blind bore 41, on the disc underside 13 facing the die table 1 of the upper stamp guide disc 4. Corresponding recesses, holding rings and sealing elements are also disposed in the lower stamp guide disc for each lower stamp. As can easily be seen from FIG. 1 and as is explained below, the holding ring 40, that can e.g. be glued in the recess 40, has a holding collar 42 at a distance from the underside of the disc 13 to which the stamp sealing element 20 is releasably fixed.

The structure of the stamp sealing element 20 will now first be explained with reference to FIG. 2. The stamp sealing element 20 shown in FIG. 2, which is preferably made from an elastomer suitable for foodstuffs or medicament manufacture with adequate sealing characteristics, is a one-piece moulded or cast part with rotational symmetry, with a base section 21 and a sleeve section 22 that is axially attached to this. In the base section 21, directly adjacent to the sleeve section 22, the stamp sealing element 20 has an undercut 23 on its inner side, the diameter and depth of which are adapted to the dimensions of the holding collar (42, FIG. 1) of the holding ring (40, FIG. 1) and e.g. can be attached to the holding collar with no, or with minimum, play. For releasable attachment, especially by clipping on, an engagement projection 25 is disposed adjacent to the undercut 23 directed towards the outside or underside 24 of the base section 21, this being able to abut on the rear side of the holding collar (42, FIG. 1) of the holding ring, engaging behind this in the installed state. The concentrically-circulating engagement projection 25 opens around in a funnel-shaped expanding ring land 26, the wall thickness of which is substantially less than the wall thickness of the base section 21 in the area of the engagement projection 25. The outside of the base section 21 has a contraction 27 in the transition section between the ring land 26 and the engagement projection 25, i.e. the outer wall 28 of the base section 21 extends conically inwards to the contraction 27 and then outwards to the underside 24 of the base section 21. Directly adjacent to the base section 21, the sleeve section 22 has a reinforcement bulge 29 that forms a limiting wall of the undercut 23 with its free upper wall 30 in the interior of the stamp sealing element and abuts on the holding collar (42, FIG. 1) of the holding ring in the installed state. A wing-collar shaped section 31, angled obliquely to the central axis A, preferably inclined by about 15° from the vertical, is attached to the reinforcement bulge 29 of the sleeve section 22, which forms a scraper lip 34 with its lower, free end 32 on the threshold surface to the inner wall 33, abutting in the installed state on the stamp shaft (5, FIG. 1) of the upper or lower stamp and scraping off any press dust adhering to the stamp shaft during the up and down movement of the stamp. As can be seen in FIG. 2, the inner wall 33 is substantially concavely curved and ends on the inner upper wall 30 of the sleeve section 22 or the reinforcement bulge 29 in a second, internal scraper lip 35. The internal diameter of the stamp sealing element 20 is equal in magnitude at the height of the first scraper lip 34 and the second scraper lip 35 and in each case comprises the smallest internal diameter of the entire stamp sealing element 20. In the area of the sleeve section 29, the outer side 36 extends cylindrically to the height of the root of the wing-collar shaped section 31, in the area of which the outer wall 37 extends inwards. The wall thickness of the stamp sealing element 20 tapers slightly in the section 31.

The engagement projection 25 is offset radially outwards in the base section 21, compared to the inner wall 33 in the sleeve section 22, so that the stamp sealing element 20 abuts in a comparatively laminar fashion with the upper wall on the side of the holding collar that faces the die table, but grips behind this with a smaller surface; this offset substantially simplifies subsequent installation or removal of the stamp sealing element 20 onto or from the holding collar. For installation or removal, the engagement projection 25 can be expanded outwards by enveloping the ring land 26, this expansion retracting automatically due to the elasticity of the material of the stamp sealing element 20 after installation is complete. In the installed state, as shown in FIG. 1, the underside 24 of the base section 21 abuts on the stamp guide disc 4 since the axial length of the base section 21 between the engagement projection 25 and the underside 24 of the base section 21 is greater than the distance between the holding collar 42 and the underside 13 of the stamp guide disc. Hence in the installed state, on the one hand the two scraper lips 34 and 35, that lie closely against the stamp shaft 5, form a seal to prevent the incursion of product dust into the stamp guide 7, and on the other hand the abutment of the underside 24 of the stamp sealing element 20 also prevents the incursion of press dust into the funnel-shaped expansion in the area of the ring land 26.

FIG. 3 shows an alternative embodiment example for a stamp sealing element 120. Here, FIG. 3 shows the installed state of the stamp sealing element 120 on the holding collar 42 of a holding ring 40, which is glued with its base ring 43 in a recess 41 in an upper or lower stamp guide disc 104, not further illustrated. The holding collar 42 is connected to the base ring 43 via a cylindrical sleeve section 44 and is at a distance from this. In the area of the base section 121, the stamp sealing element 120 is identical to that described in the embodiment example according to FIG. 1, so a renewed description of the structure of the undercut 123 and the engagement projection 125 will not be given. The underside 124 of the base section 121 abuts on the underside 113 of the stamp guide disc in a sealing manner. Furthermore, it can be seen that the undercut 123 can accept the holding collar 42 of the holding ring 40 with a small amount of play. Differently to the sealing element according to the first embodiment example, on the inner wall of the 133 of the sleeve section 122 the stamp sealing element 120 is only provided with one scraper lip 134 on the free edge of the sleeve section 122, whilst the inner wall 133 extends cylindrically in the area of the reinforcement bulge 129. The narrowest internal diameter of the sealing element 120 is exclusively at the scraper lip 134 and only this abuts on the stamp shaft.

A range of modifications arise for the skilled person from the description given hereinbefore that should fall within the protection scope of the following claims. The proportions and dimensions of the illustrated stamp sealing element are matched to the dimensions of the holding rings used on the Applicant's machines. A different structure may be preferable for other holding rings. The undersides of the sealing elements could also be at a distance from the stamp guide discs in the installed state. The embodiment form with the internal scraper and hold-back lip for the lubricant comprises the preferred embodiment example, especially for the seal of the stamp shafts on the upper stamp guide disc. Furthermore, it is clear to the skilled person that sealing elements that are intended for use with rotary tablet presses, that have the structure specified in the claims and that are attachable, insertable or clippable onto holding rings of tablet presses should fall under the protection scope of the following claims.

1. A rotary tablet press with a rotating die table, comprising stamp guide discs being moveable with the die table, stamp guides for the shafts of upper and lower stamps coaxial to dies on the die table, elastic stamp sealing elements for each said upper and lower stamp, the stamp sealing elements presenting rotational symmetry and attachable with their base section to the stamp guide discs concentrically about the stamp guides to form a seal between a pressing area on the die table and the stamp guides, a base section of stamp sealing element said base section has an undercut by means of which the sealing element can be releasably attached to a holding collar of a holding ring disposed concentrically about the stamp guide, and that the base section passes into a substantially axially-extending sleeve section, a free end of which forms a scraper lip, abutting in a sealing manner on the stamp shaft.

2. A rotary tablet press according to claim 1, wherein the sleeve section has a reinforcement bulge adjacent to the undercut.

3. A rotary tablet press according to claim 2, wherein the sleeve section extends obliquely inwards in the shape of a wing-collar.

4. A rotary tablet press according to claim 2, wherein the sleeve section is substantially concavely curved on its inner wall and forms an inner scraper lip with a inner threshold edge of the inner wall.

5. A rotary tablet press according to claim 2, wherein wherein the inner wall of the sleeve section is cylindrical apart from the oblique, wing-collar shaped section.

6. A rotary tablet press according to claim 1, wherein the base section has an engagement projection adjacent to the undercut.

7. A rotary tablet press according to claim 6, wherein the engagement projection is offset radially outwards compared to the inner wall of the sleeve section.

8. A rotary tablet press according to claim 6, wherein the engagement projection opens into a funnel-shaped expanding ring land towards the underside of the stamp sealing element, the wall thickness of which is less than 50% of the wall thickness in the area of the engagement projection.

9. A rotary tablet press according to claim 6, wherein the axial length of the base section between the engagement projection and its underside is greater than the distance between the holding collar and the stamp guide disc.

10. A rotary tablet press according to claim 6, wherein the outer wall of the stamp sealing element has a contraction in the base section between the funnel-shaped ring land and the back of the engagement projection.

11. A sealing element for a rotary tablet press with rotating die table comprising stamp guide discs being moveable with the die table, stamp guides for shafts of upper and lower stroking stamps coaxial to dies on the die table, wherein elastic sealing elements presenting rotational symmetry are provided for each said upper and lower stamp as a seal between the pressing area on the die table and the stamp guides, which sealing elements are attachable with their base section to the stamp guide discs concentrically about the stamp guides, the sealing element comprises a base section with an undercut by means of which the sealing element can be releasably attached to a holding collar of a holding ring disposed concentrically about the stamp guide, and that the base section passes into a substantially axially-extending sleeve section, a free end of which forms a scraper lip, abutting in a sealing manner on the stamp shaft.

12. A rotary tablet press according to claim 3 wherein the sleeve section tapers between the reinforcement bulge and the scraper lip.

13. A rotary tablet press according to claim 3, wherein the sleeve section is substantially concavely curved on its inner wall and forms an inner scraper lip with a inner threshold edge of the inner wall.

14. A rotary tablet press according to claim 3, wherein the inner wall of the sleeve section is cylindrical apart from the oblique, wing-collar shaped section.

15. A rotary tablet press according to claim 7, wherein the engagement projection opens into a funnel-shaped expanding ring land towards the underside of the stamp sealing element, the wall thickness of which is less than 50% of the wall thickness in the area of the engagement projection.

16. A rotary tablet press according to claim 2, wherein the base section has an engagement projection adjacent to the undercut.

17. A rotary tablet press according to claim 3, wherein the base section has an engagement projection adjacent to the undercut.

18. A rotary tablet press according to claim 16, wherein the engagement projection is offset radially outwards compared to the inner wall of the sleeve section.

19. A rotary tablet press according to claim 17, wherein the engagement projection is offset radially outwards compared to the inner wall of the sleeve section.

20. A rotary tablet press according to claim 7, wherein the axial length of the base section between the engagement projection and its underside is greater than the distance between the holding collar and the stamp guide disc.
